(19) United States
(12) Patent Application Publication
(10) Pub. No.: US 2003/0099803 A1
(43) Pub. Date: May 29, 2003

(54) Magnetic recording medium

(75) Inventor: Kazuhiro Niitsuma, Kanagawa-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/303,718

(22) Filed: Nov. 26, 2002

(30) Foreign Application Priority Data
Nov. 26, 2001 (JP) 359289/2001

(51) Int. Cl. B32B 3/02

(52) U.S. Cl. 428/64.2; 428/65.3

(57) ABSTRACT

A magnetic recording medium comprising a card-type disk drive and a magnetic disk cartridge. The card-type disk drive is loaded in a card slot of electronic equipment. The magnetic disk cartridge has a magnetic disk rotatably supported within a housing, and is inserted into and ejected from the disk drive through a cartridge-inserting slot. The magnetic disk cartridge includes an ejection manipulation member that has a push manipulation portion and a leading end portion. The leading end portion protrudes from the front wall of the housing when the push manipulation portion is pushed in a cartridge-inserting direction. The disk drive has cartridge ejection means for moving the magnetic disk cartridge in a cartridge-ejecting direction when the leading end portion of the ejection manipulation member protrudes from the front wall of the housing.

### BACKGROUND OF THE INVENTION

1. Field of the Invention

The present invention relates generally to a magnetic recording medium equipped with a card-type disk drive which can be loaded in the card slot of electronic equipment (such as a digital still camera, a digital video camera, a laptop personal computer, etc.) and a magnetic disk cartridge which can be inserted and ejected through the cartridge-inserting slot of the disk drive, and more particularly to an ejection mechanism for ejecting the magnetic disk cartridge from the disk drive.

2. Description of the Related Art

To record or reproduce information, a recording medium is removably loaded in the card slot of electronic equipment such as a digital still camera, a digital video camera, a notebook-sized personal computer (PC), etc. Examples of such recording media that have been put to practical use are a semiconductor memory type, a hard disk type, an optical disk type, a magnetic disk type (e.g., a floppy disk type), etc.

Among these recording media, semiconductor memories are most widely used because they are easy to handle and have a relatively large recording capacity. However, they are relatively expensive. Because of this, in digital cameras employing the semiconductor memory, the photographed image data is transferred to a PC and stored, the data is deleted from the memory, and the semiconductor memory is repeatedly used.

Although there are known hard disks that can store 340 megabytes (MB) of data or 1 gigabytes (GB) of data, they are also expensive. Because of this, data is transferred to another device and stored, and hard disks are repeatedly used.

Optical disks have a large recording capacity for their size. For example, an optical disk with a size of 35 mm×41 mm×11 mm can store 256 MB of data. Optical disks with a recording capacity of 512 MB are about to be realized. However, optical disks have the disadvantage that the recording speed is slow, because the writing time is time-consuming.

Some of the magnetic disks (e.g., floppy disks) have a small size of 50 mm×55 mm×2 mm. Such a small magnetic disk can be exchangeably loaded in a disk drive of a size that can be inserted into the card slot of a PC, etc. However, the recording capacity is as small as 40 MB and insufficient to record image data photographed by a camera. In addition, the size is not suitable for digital cameras.

With the spread of PCs, digital cameras have spread rapidly in recent years because of the simplicity of recording, enhancement in picture quality due to the development of imagers, possibility of data deletion and transmission, recording capacity size, etc. However, the method of use is restricted, because recording media are limited in cost and recording capacity, as described above. For instance, since recording media are very expensive, a single camera has only a single recording medium, which is repeatedly used. That is, when the recording medium is filled with data, the data is transferred to a PC and deleted from the recording medium as described above. Because of this, there are cases where the recording medium is filled up during a trip. In addition, the recording medium cannot be stored as is, with data contained therein, nor can it be given away to a person.

Hence, there is a demand for realization of a recording medium which is large in recording capacity, low in cost, and small in size so that the data photographed by a digital camera can be stored as is or given away to a person. In PCs, there is also a demand for realization of a recording medium which is large in recording capacity, low in cost, and small in size so that the medium with stored data can be handed to a person.

To meet the aforementioned demands, it is contemplated that the above-described inexpensive small large-capacity recording medium may comprise a card-type disk drive which is loaded in electronic equipment such as a PC and a digital camera, and a magnetic disk cartridge which is loaded in the small disk drive. That is, it is contemplated that such a magnetic disk cartridge may include a housing in which a flexible magnetic disk capable of high-density recording is rotatably housed, and have a recording capacity of 200 MB or larger. Examples of magnetic recording media with a high recording density are a recording medium with a thin metal film formed by vapor deposition, a recording medium with a thin metal film formed by sputtering, and a recording medium employing barium ferrite powder or ferromagnetic magnetic powder. An example of a magnetic recording medium with a high recording density employing barium ferrite powder is disclosed in U.S. application Ser. No. 10/266584.

The “magnetic recording medium with a high recording density employing barium ferrite powder” is a magnetic disk containing barium ferrite powder in its magnetic layer, and employs a material capable of a high recording density. The magnetic disk may comprise a magnetic recording medium. The magnetic recording medium has a non-magnetic layer which includes both non-magnetic powder and a binder, and a magnetic layer which includes both ferromagnetic powder (which is ferromagnetic metal powder or hexagonal-system ferrite powder) and a binder. The non-magnetic layer and the magnetic layer are formed on at least one surface of a non-magnetic substrate in the recited order. In the non-magnetic layer, the quantity of carbon black whose average particle diameter is 10 to 30 nm is 10 to 50 weight parts with respect to 100 weight parts of the aforementioned non-magnetic powder. The thickness of the magnetic layer is 0.2 μm or less. According to a microanalysis by an electron beam, the standard deviation (b) of the strength of an element with respect to an average strength (a) resulting from ferromagnetic powder is 0.03≦b/a≦0.4. The center plane average roughness Ra of the magnetic layer is 5 nm or less, and the 10-point average roughness Rz is 40 nm or less. In a magnetic disk employing the above-described material, information is recorded or reproduced by a magnetic head such as an MR head capable of a high recording density.

The above-described magnetic recording medium can have a recording capacity of 200 MB or larger, preferably 500 MB or larger. Therefore, if a still image has 1 MB of data per image, the magnetic recording medium can store 500 image. In the case of a motion picture, the magnetic recording medium can store image contents of about 30 minutes. Thus, the magnetic recording medium can store a motion picture photographed by a digital camera, or a motion picture transmitted by a portable telephone. As a result, users can conveniently use the magnetic recording medium. Furthermore, the magnetic recording medium can be conveniently used in PCs as an inexpensive large-capacity recording medium. Thus, the convenience is great.

Card-type disk drives are employed in electronic equipment such as a PC, a digital camera, etc. In the case of PCs, as shown in FIG. 8A, a disk drive 6 is connected electrically with the socket 4 of a card 2 that is inserted in the card slot of a PC. In the case of small electronic equipment such as a digital camera 3 shown in FIG. 8B, a disk drive 6 is connected electrically with the socket of the receiving portion 5 of the camera 3. Therefore, the disk drive 6 is extremely small in size and has, for example, a length of 38 to 55 mm, a width of 35 to 51 mm, and a thickness of 3 to 5 mm. A magnetic disk cartridge 8 is inserted into the disk drive 6 through a slot formed in the disk drive 6, and has, for example, a length and a width of 25 to 36 mm and a thickness of 1 to 3 mm.

In conventional disk drives for floppy disks, if a magnetic disk cartridge is inserted into the disk drive, a cartridge ejection button protrudes from the front wall of the disk drive. The above-described card-type disk drives that can be loaded in the card slot of electronic equipment are standardized. Therefore, if the ejection button protrudes, or if the magnetic disk cartridge protrudes from the disk drive, there is a possibility that the protruded portion will interfere with the main body of electronic equipment.

### SUMMARY OF THE INVENTION

The present invention has been made in view of the above-described circumstances. Accordingly, it is the primary object of the present invention to provide a magnetic recording medium which is capable of easily ejecting its magnetic disk cartridge from a disk drive, while eliminating a portion of the magnetic disk cartridge that protrudes from the disk drive, such as an ejection button, when the magnetic disk cartridge is loaded in the disk drive.

To achieve this end and in accordance with the present invention, there is provided a magnetic recording medium comprising a card-type disk drive and a magnetic disk cartridge. The card-type disk drive is loaded in a card slot of electronic equipment. The magnetic disk cartridge has a magnetic disk rotatably supported within a housing, and is inserted into and ejected from the disk drive through a cartridge-inserting slot. The magnetic disk cartridge includes an ejection manipulation member that has a push manipulation portion and a leading end portion. The leading end portion protrudes from the front wall of the housing when the push manipulation portion is pushed in a cartridge-inserting direction. The disk drive has cartridge ejection means for moving the magnetic disk cartridge in a cartridge-ejecting direction when the leading end portion of the ejection manipulation member protrudes from the front wall of the housing.

In the magnetic recording medium of the present invention, it is preferable that the aforementioned ejection manipulation member be slidably provided along a side wall of the housing which extends in the cartridge-ejecting direction. It is also preferable that the rear wall of the housing of the magnetic disk cartridge have a cutout which allows the push manipulation portion of the ejection manipulation member to be pushed in the cartridge-inserting direction.

In the magnetic recording medium of the present invention, the cartridge-inserting slot of the disk drive is preferably provided with a cutout which allows the push manipulation portion of the ejection manipulation member to be pushed in the cartridge-inserting direction.

Preferably, the cartridge ejection means of the disk drive is constructed to push an end portion of the front wall of the housing which is opposite to the leading end portion of the ejection manipulation member when the leading end portion of the ejection manipulation member protrudes from the front wall of the housing. The cartridge ejection means may comprise a swinging member having a see-saw structure.

According to the present invention, the magnetic disk cartridge is equipped with the ejection manipulation member that has the leading end portion. The leading end portion protrudes from the front wall of the housing when the push manipulation portion is pushed in the cartridge-inserting direction. Therefore, when the magnetic disk cartridge is loaded in the disk drive, there is no possibility that a portion of the magnetic disk cartridge will protrude from the disk drive. Thus, the magnetic recording medium of the present invention is capable of preventing interference between the disk drive and the main body of electronic equipment, while facilitating the ejection of the magnetic disk cartridge from the disk drive.

The ejection manipulation member is slidably provided along the side wall of the housing parallel to the direction in which the housing is inserted into the disk drive. Therefore, there is no possibility that the ejection manipulation member will narrow the space for housing the magnetic disk.

The disk drive is equipped with cartridge ejection means for moving the magnetic disk cartridge in the cartridge-ejecting direction when the leading end portion of the ejection manipulation member protrudes from the front wall of the housing. With this simple structure, the magnetic disk cartridge can be easily ejected from the disk drive.

### BRIEF DESCRIPTION OF THE DRAWINGS

The present invention will be described in further detail with reference to the accompanying drawings wherein:

FIG. 1 is a schematic plan view showing a magnetic disk cartridge which forms part of a magnetic recording medium constructed in accordance with a preferred embodiment of the present invention;

FIG. 2 is a schematic plan view of the ejection manipulation member shown in FIG. 1;

FIG. 3 is a schematic plan view showing how the ejection manipulation member shown in FIG. 1 is operated;

FIG. 4 is a schematic sectional view showing a disk drive which forms part of the magnetic recording medium of the present invention;

FIG. 5 is a schematic sectional view showing the state in which the magnetic disk cartridge of FIG. 1 is loaded in the disk drive of FIG. 4;

FIG. 6 is a schematic sectional view showing how the ejection manipulation member shown in FIG. 5 is operated;

FIG. 7 is a plan view showing the magnetic disk cartridge ejected from the disk drive by pushing the ejection manipulation member in the cartridge-inserting direction;

FIG. 8A is a perspective view showing a conventional disk drive on which the present invention is based, and-electronic equipment with a card slot in which the disk drive is loaded; and

FIG. 8B is a side views showing another conventional disk drive on which the present invention is based, and electronic equipment with a card slot in which the disk drive is loaded.

### DESCRIPTION OF THE PREFERRED EMBODIMENT

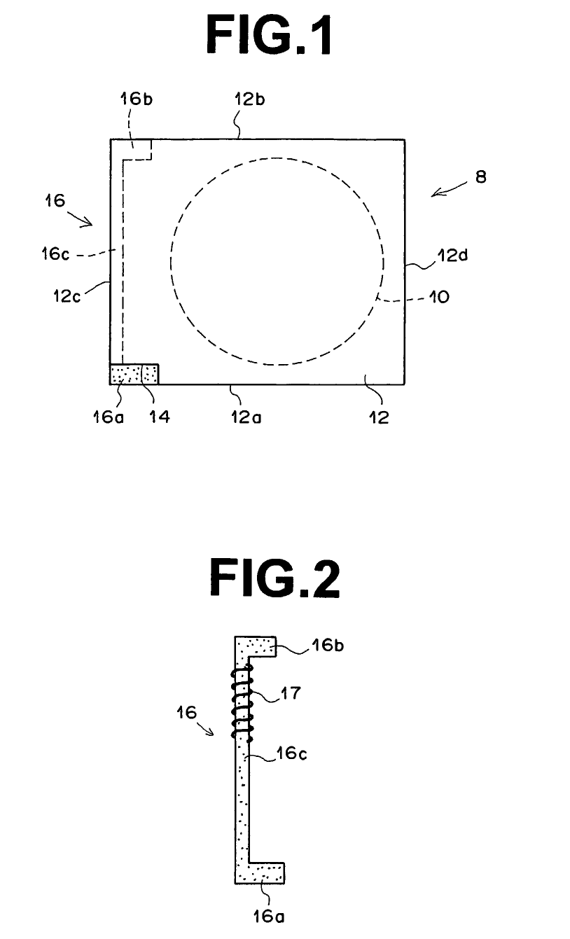

Referring now to FIGS. 1 to 4, there is shown a magnetic recording medium constructed in accordance with a preferred embodiment of the present invention. The magnetic recording medium comprises a magnetic disk cartridge 8 and a disk drive 6 in which the cartridge 8 is loaded.

The magnetic disk cartridge 8 includes a flat rectangular housing 12 in which a magnetic disk 10 is rotatably supported. The housing 12 is equipped with a front wall 12b disposed on leading side of the inserting direction of the magnetic disk cartridge 8 into the disk drive 6; a rear wall 12a disposed on the trailing side of the cartridge-inserting direction; left and right sides walls 12c and 12d; and a cutout 14 formed in the corner between the right side wall 12c and the rear wall 12a.

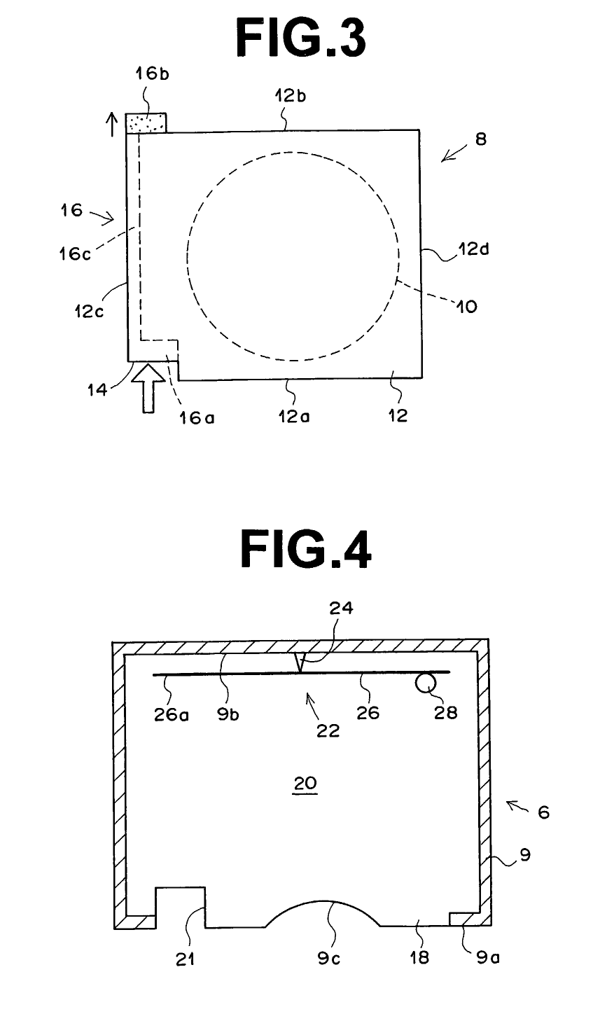

Near the left side wall 12c, an ejection manipulation member 16 is provided slidably along the left side wall 12c. The ejection manipulation member 16, as shown in FIG. 2, has a button-shaped push manipulation portion 16a, a leading end portion 16b, and a connection portion 16c extending between the push manipulation portion 16a and the leading end portion 16b. The length of the ejection manipulation member 16 is approximately the same as the length of the left side wall 16c of the housing 12. The push manipulation portion 16a of the ejection manipulation portion 16 is disposed within the cutout 14 and coplanar with the rear wall 12a of the housing 12. The leading end portion 16b is likewise coplanar with the front wall 12b of the housing 12. If the push manipulation portion 16a is pushed in the cartridge-inserting direction, it is moved forward beyond the cutout 14 and the leading end portion 16b protrudes from the front wall 12b, as shown in FIG. 3. The ejection manipulation member 16 is urged toward the rear wall 12a by a return spring 17 (FIG. 2). If the pushing of the push manipulation portion 16a of the ejection manipulation member 16 is stopped, then the ejection manipulation member 16 returns to the initial state shown in FIG. 1.

In addition to the above-described components, the housing 12 of the magnetic disk cartridge 8 is equipped with an opening (not shown) and a shutter (not shown) that opens and closes to expose the recording surface of the magnetic disk 10 through the opening. Since they do not form part of the present invention, a detailed description of them will not be given.

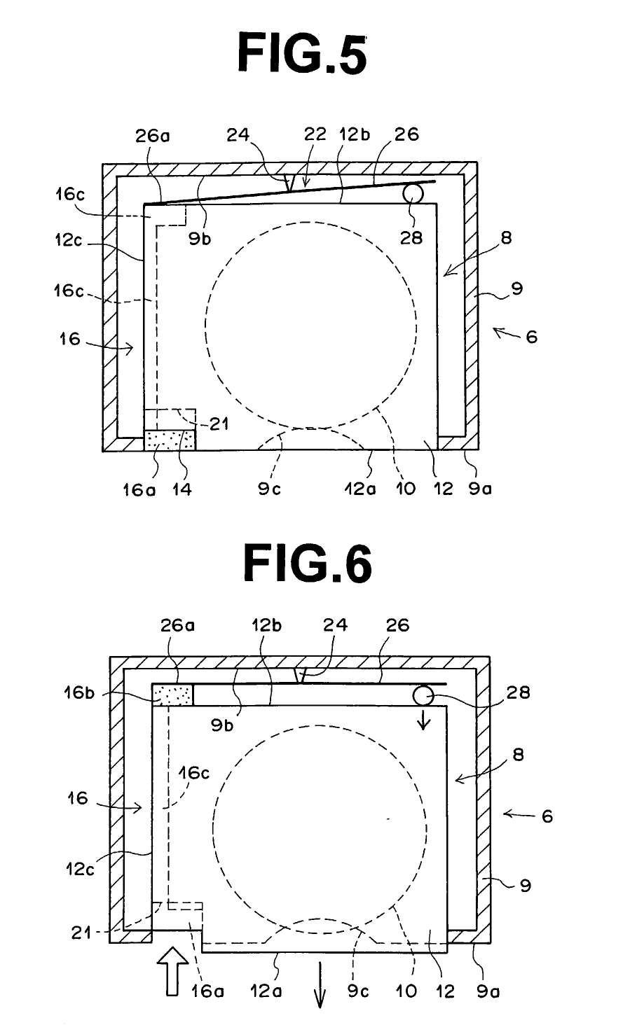

On the other hand, the housing 9 of the disk drive 6 shown in FIG. 4 is equipped with an exterior wall 9a having a cartridge-inserting slot 18; cartridge housing space 20; an interior wall 9b on the back side of the cartridge housing space 20; and an arcuate cutout 9c formed in the cartridge-inserting slot 18 of the central portion of the exterior wall 9a. The housing 9 of the disk drive 6 is further equipped with a push manipulation cutout 21 which makes the pushing of the push manipulation portion 16a of the ejection manipulation member 16 possible when the magnetic cartridge 8 is being loaded within the cartridge housing space 20, as shown in FIG. 5.

The disk drive 6 is equipped with cartridge ejection means 22, which is provided on the interior wall 9b of the housing 9. The cartridge ejection means 22 includes a support member 24 fixed at the substantial center of the interior wall 9b of the housing 9; a swinging member 26 that swings in the manner of a see-saw within a plane parallel to the drawing sheet, using the supporting member 24 as a fulcrum; and a cartridge-pushing member 28 protruding from the right end portion of the swinging member 26 toward the cartridge-inserting slot 18.

In addition to the above-described components, the disk drive 6 is further equipped with a drive mechanism for rotating the magnetic disk 10 of the magnetic disk cartridge 8, a magnetic head, a magnetic-head moving mechanism, and an electrically connecting member that electrically connects these mechanisms with electronic circuitry provided within electronic equipment. Since they do not form part of the present invention, detailed descriptions and illustrations of them will be omitted.

If the magnetic disk cartridge 8 is inserted into the disk drive 6 through the cartridge-inserting slot 18, as shown in FIG. 5, the leading end portion 16b of the ejection manipulation member 16 of the magnetic disk cartridge 8 is brought into contact with the left end portion 26a of the swinging member 26, and the right end portion of the front wall 12b of the housing 12 of the magnetic disk cartridge 8 is brought into contact with the cartridge-pushing member 28 that projects from the right end portion of the swinging member 26.

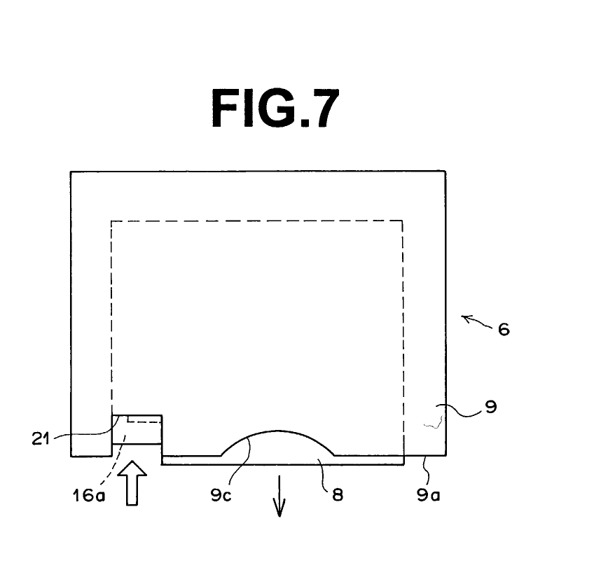

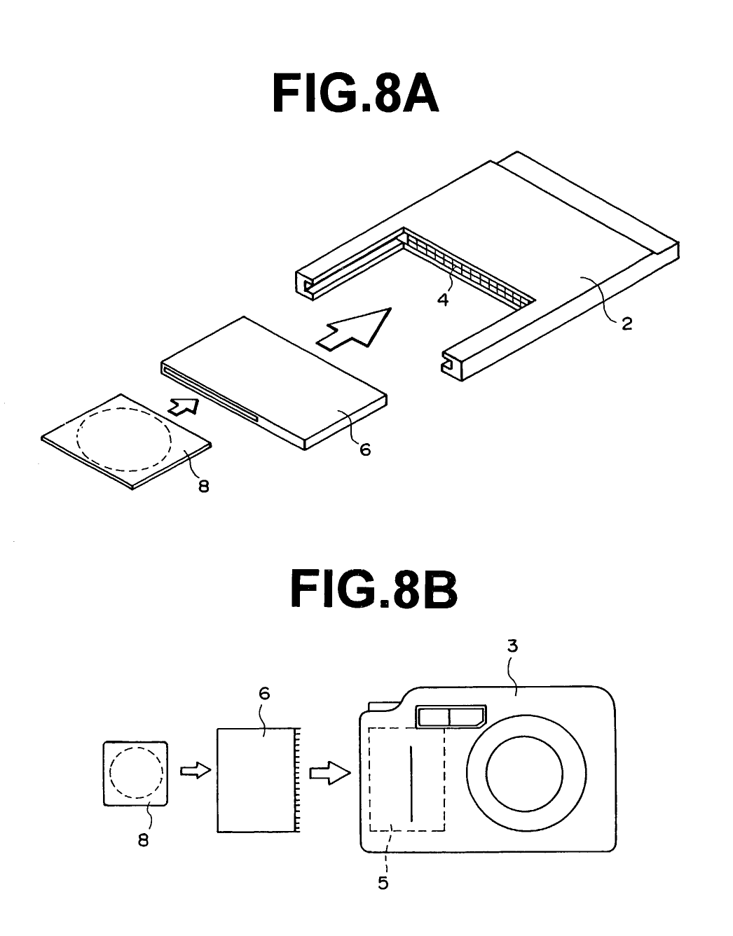

When the magnetic disk cartridge 8 is ejected from the disk drive 6, the push manipulation portion 16a of the ejection manipulation member 16 of the magnetic disk cartridge 8 is pushed. The pushing of the push manipulation portion 16a causes the leading end portion 16b of the ejection manipulation member 16 to protrude from the front wall 12b of the housing 12 of the magnetic disk cartridge 8. As shown in FIG. 6, the swinging member 26 swings on the supporting member 24 in the clockwise direction, so the front wall 12b of the housing 12 of the magnetic disk cartridge 8 is pushed toward the cartridge-inserting slot 18 by the cartridge-pushing member 28. As a result, the magnetic disk cartridge 8 is ejected from the disk drive 6 through the cartridge-inserting slot 18, as shown in FIGS. 6 and 7.

As set forth in the preferred embodiment, the present invention has the following advantages:

(1) The magnetic disk cartridge 8 is equipped with the ejection manipulation member 16 that has the leading end portion 16b. The leading end portion 16b protrudes from the front wall 12b of the housing 12 when the push manipulation portion 16a is pushed in the cartridge-inserting direction. Therefore, when the magnetic disk cartridge 8 is loaded in the disk drive 6, the ejection of the magnetic disk cartridge 8 from the disk drive 6 is facilitated and there is no possibility that a portion of the magnetic disk cartridge 8 will protrude from the disk drive 6. As a result, interference with the main body of electronic equipment can be prevented.

(2) The ejection manipulation member 16 is slidably provided along the side wall 12c of the housing 12 parallel to the direction in which the housing 12 is inserted into the disk drive 6. Therefore, there is no possibility that the ejection manipulation member 16 will narrow the space for housing the magnetic disk 10.

(3) The cartridge ejection means 22 of the disk drive 6 is equipped with the swinging member 26 that swings by protrusion of the leading end portion 16b of the ejection manipulation member 16 of the magnetic disk cartridge 8. With this simple structure, the magnetic disk cartridge 8 can be ejected from the disk drive 6.

(4) The disk drive 6 is further equipped with the arcuate cartridge-ejecting cutout 9c formed in the cartridge-inserting slot 18 of the central portion of the rear wall 9a of the housing 12. This enables fingers to hold the cartridge 8 easily when it is ejected from the disk drive 6.

While the present invention has been described with reference to the preferred embodiment thereof, the invention is not to be limited to the details given herein, but may be modified within the scope of the invention hereinafter claimed.

What is claimed is:

1. A magnetic recording medium comprising:
a card-type disk drive which is loaded in a card slot of electronic equipment; and
a magnetic disk cartridge which has a magnetic disk rotatably supported within a housing, and which is inserted into and ejected from said disk drive through a cartridge-inserting slot;
wherein said magnetic disk cartridge includes an ejection manipulation member which has a push manipulation portion and a leading end portion, and said leading end portion protrudes from a front wall of said housing when said push manipulation portion is pushed in a cartridge-inserting direction;
and wherein said disk drive has cartridge ejection means for moving said magnetic disk cartridge in a cartridge-ejecting direction when the leading end portion of said ejection manipulation member protrudes from the front wall of said housing.

2. The magnetic recording medium as set forth in claim 1, wherein said ejection manipulation member is slidably provided along a side wall of said housing which extends in said cartridge-ejecting direction.

3. The magnetic recording medium as set forth in claim 1, wherein a rear wall of the housing of said magnetic disk cartridge has a cutout which allows the push manipulation portion of said ejection manipulation member to be pushed in said cartridge-inserting direction.

4. The magnetic recording medium as set forth in claim 1, wherein the cartridge-inserting slot of said disk drive is provided with a cutout which allows the push manipulation portion of said ejection manipulation member to be pushed in said cartridge-inserting direction.

5. The magnetic recording medium as set forth in claim 1, wherein the cartridge ejection means of said disk drive is constructed to push an end portion of the front wall of said housing which is opposite to the leading end portion of said ejection manipulation member when the leading end portion of said ejection manipulation member protrudes from the front wall of said housing.

6. The magnetic recording medium as set forth in claim 5, wherein said cartridge ejection means comprises a swinging member having a see-saw structure.
